(19) United States
(12) Patent Application Publication
(10) Pub. No.: US 2012/0254024 A1
(43) Pub. Date: Oct. 4, 2012

(54) Pay-Per-Use License Management for Software Applications

(75) Inventors: Abhijit Bose, Paramus, NJ (US); Shang Q. Guo, Cortland Manor, NY (US); Jonathan Lenchner, North Salem, NY (US); Mattias Marder, Haifa (IL)

(73) Assignee: INTERNATIONAL BUSINESS MACHINES CORPORATION, Armonk, NY (US)

(21) Appl. No.: 13/075,643

(22) Filed: Mar. 30, 2011

(51) Int. Cl. G06Q 20/22

(52) U.S. Cl. 705/40

(57) ABSTRACT

Methods and apparatus are provided for managing pay-per-use licensing models that determine a licensing fee based on user consumption. A client-side method is provided for monitoring usage of a portion of a software application by a user, by monitoring actions of the user at an image level; determining if one or more predefined user actions are detected, wherein the predefined user actions comprise usage of a function of the software application; and providing a notification of the predefined user actions to a mediation server for payment processing. The notifications are optionally performed periodically for a plurality of the notifications. Execution of the software application can optionally be suspended if payment is not made for the usage, or if the notification is not received by the mediation server.

### FIELD OF THE INVENTION

The present invention relates generally to the field of software license management, and more particularly, to techniques for managing a pay-per-use model for software licensing.

### BACKGROUND OF THE INVENTION

Software plays a valuable role for most business and personal users. Software has typically been licensed using a perpetual software license. With a perpetual software license, the user pays for the software once and has a license to use the entire software package. In an enterprise setting, a copy of a particular software product must typically be licensed for each user. Generally, a perpetual software license employs a uniform pricing strategy that is tailored to heavy users of the software product. Many software users, however, do not wish to pay full price for a complete software package, when they use the software infrequently or use only a subset of the available features and/or functions of the complete software package.

Software vendors can further leverage their software products by licensing the software products to those users who are interested in only a subset of the available features, but are unwilling to pay the full price to purchase the complete software package. A number of techniques have been proposed or suggested for implementing pay-per-use licensing models for software. The majority of pay-per-use licensing models are implemented in the server and are targeted to web applications/services. For example, software-as-a-service (SaaS) providers, such as Amazon.com Inc., offer pricing schemes that are based on pay-per-use models. For example, the Elastic Compute Cloud (EC2) service from Amazon allows companies to host their own software and pay for it based on the number of application-hours used. In addition, the music industry has shifted from primarily selling music in the form of complete compact disks (CDs) to primarily selling individual songs to consumers.

A need remains for methods and apparatus for managing pay-per-use licensing models that determine a licensing fee based on user consumption. Yet another need exists for methods and apparatus for managing pay-per-use licensing models that allow a user to obtain and pay for software at a more granular level than with a conventional perpetual model.

### SUMMARY OF THE INVENTION

Generally, methods and apparatus are provided for managing pay-per-use licensing models that determine a licensing fee based on user consumption. According to one aspect of the invention, a client-side method is provided for monitoring usage of a portion of a software application by a user, by monitoring actions of the user at an image level; determining if one or more predefined user actions are detected, wherein the predefined user actions comprise usage of a function of the software application; and providing a notification of the predefined user actions to a mediation server for payment processing. The notifications are optionally performed periodically for a plurality of the notifications. Execution of the software application can optionally be suspended if payment is not made for the usage, or if the notification is not received by the mediation server.

In one implementation, a centralized mediation server determines a license fee for the predefined user actions. The determined license fee can be based, for example, on an amount of use and/or an identifier of the function associated with a given predefined user action. The mediation server can determine the payment based on software usage agreements for monitored software applications and/or usage reports. The software usage agreements can comprise, for example, policies and rules for specifying a payment amount for the functions of a given software application.

The user actions can be monitored, for example, by sampling user interface interactions of the user with the software application. For example, one or more of menu selections, mouse button selections, mouse button click operations, additional user interface widgets and short cut keystrokes can be monitored. In addition, an image in a vicinity of the user action can be sampled and matched to determine a type of selection and instance of the selection. In one exemplary implementation, the sampling is performed by a Screen Scraping tool or a user interface widget.

Amore complete understanding of the present invention, as well as further features and advantages of the present invention, will be obtained by reference to the following detailed description and drawings.

### BRIEF DESCRIPTION OF THE DRAWINGS

FIG. 1 illustrates an exemplary implementation of a pay-per-use license management system incorporating features of the present invention;

FIG. 2 is a flow chart describing an exemplary implementation of a client-side monitoring program that incorporates features of the present invention;

FIG. 3 illustrates an exemplary usage record incorporating features of the present invention;

FIGS. 4A through 4C are flow charts describing an exemplary implementation of various routines implemented by an exemplary mediator that incorporates features of the present invention;

FIG. 5 is an exemplary representation of a software usage agreement for a given monitored application; and

FIG. 6 illustrates an exemplary graphical user interface (GUI) that allows a user to implement an exemplary save operation within an application.

### DETAILED DESCRIPTION OF PREFERRED EMBODIMENTS

The present invention provides methods and apparatus for managing pay-per-use licensing models for software. The disclosed pay-per-use license management system determines a licensing fee based on user consumption. According to one aspect of the invention, a monitoring and metering application monitors the use of the software on the client machine and sends a usage report to a Payment Mediator executing on a server or in a compute cloud. The Payment Mediator charges the end-user based on rules in a software usage agreement, which can vary for each software product. In this manner, rules can be established to charge the end-user for a feature the first time the user uses the feature, the nth time the user uses the feature, or charge a rate based on how often a given feature or feature set is used by the user. Among other benefits, no changes are required to software application. Rather, payment terms are completely enforced by one or more monitoring and metering applications that are independent of the software application.

In one exemplary implementation, software vendors can specify payment terms in XML or another uniform format. In this manner, the payment terms can optionally be displayed to the user in a uniform fashion for all software by the disclosed monitoring/metering application. The usage reports generated in accordance with the present invention can optionally be provided to both the software users and software vendors.

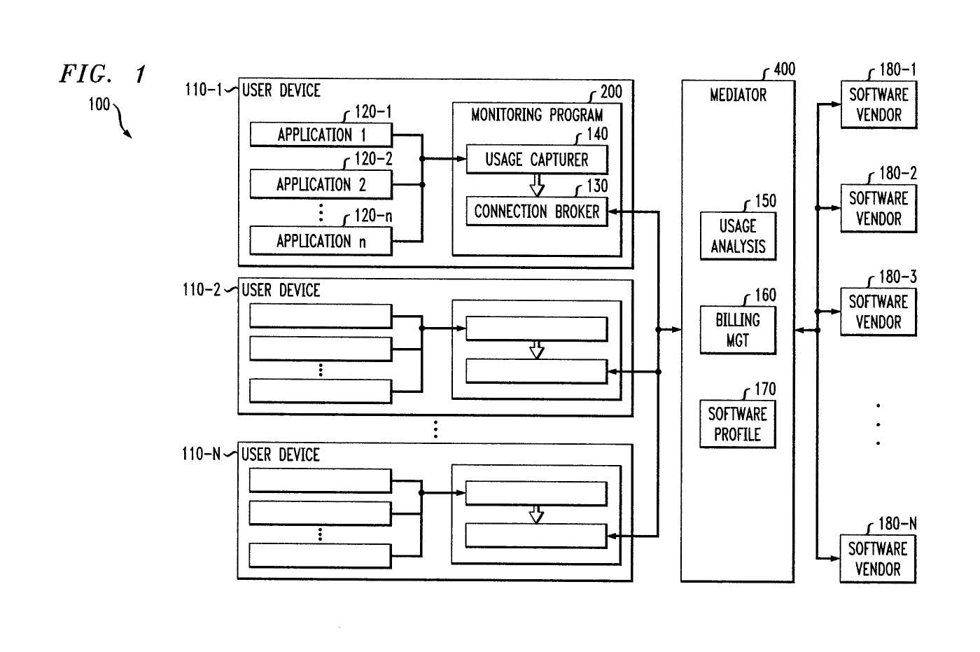

FIG. 1 illustrates an exemplary implementation of a pay-per-use license management system 100 incorporating features of the present invention. As shown in FIG. 1, the exemplary pay-per-use license management system 100 comprises a plurality of user devices 110-1 through 110-N (collectively, referred to herein as user devices 110) that execute one or More software applications 120-1 through 120-N (collectively, referred to herein as software applications 120). The software applications 120-1 through 120-N are provided by one or more software vendors 180-1 through 180-N.

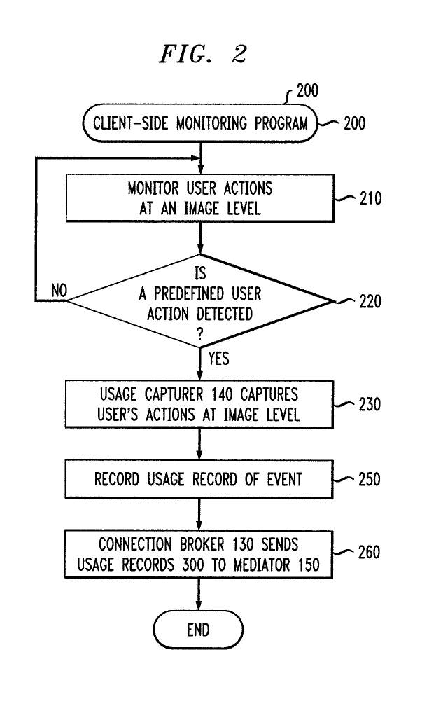

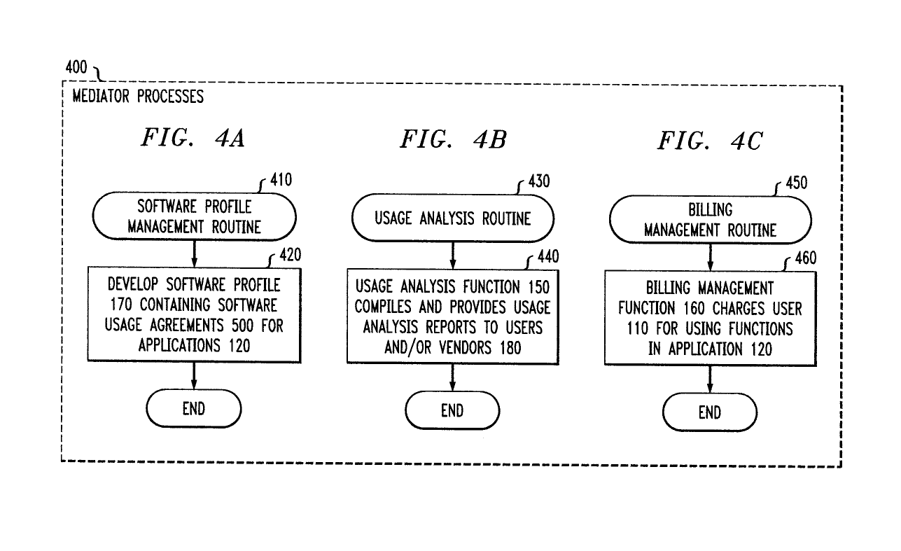

According to one aspect of the invention, a client-side monitoring program 200, as discussed further below in conjunction with FIG. 2, monitors the usage by the user of one or more of the software applications 120. As shown in FIG. 1 and discussed further below, the exemplary client-side monitoring program 200 comprises a connection broker 130 and a usage capturer 140. Generally, the usage capturer 140 captures and records user actions at an image level and the connection broker 130 sends usage records to a centralized mediator 400 for further processing. As shown in FIG. 1, and as discussed further below in conjunction with FIGS. 4A-4C, the exemplary mediator 400 comprises a usage analysis tool 150, a billing management tool 160, and a software profile 170.

FIG. 2 is a flow chart describing an exemplary implementation of a client-side monitoring program 200 that incorporates features of the present invention. As shown in FIG. 2, the client-side monitoring program 200 initially monitors user actions at an image level during step 210. A test is performed during step 220 to determine if a predefined user action is detected. In one exemplary implementation, during the user's work with the target application 120 and upon each user interface (UI) widget interaction, such as a menu selection, a selection from a right mouse button menu or a mouse click on a button, the image around the marker coordinates (i.e. coordinates of the event signaling the interaction) is sampled and matched to determine the type of selection (menu selection, right mouse button menu selection, button click, etc.) and instance (i.e. which menu selection was chosen or which button was clicked on).

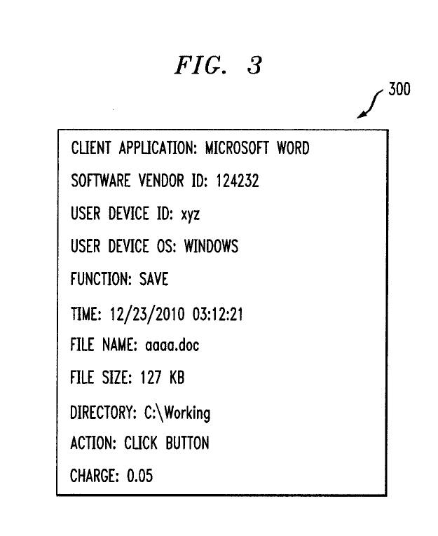

If it is determined during step 220 that a predefined user action is not detected, then program control returns to step 210. If, however, it is determined during step 220 that a predefined user action is detected, then the usage capturer 140 captures the user's actions at an image level during step 230. The user's actions can be captured, for example, via a Screen Scraping tool, using, for example, the techniques described in United States Patent Application Publication Nos. 2008/0001959 and 2009/0273597, each incorporated by reference herein. The Screen Scraping tool can capture, for example, an indication of the menu selection or button the user clicks, or the keystrokes command shortcuts for the function) the user enters through Operating System (OS) events. The use of an independent tool to capture the user's actions allows the present invention to be implemented without significant changes, if any, to the software applications 120. In a further variation, the user's actions can be obtained from a user interface widget that is instrumented to report when the widget is used. This instrumentation can be done once at the operating system level (for example, within the Windows Software Development Kit (SDK)) and then utilized by any application 120 using that SDK. A usage record 300, as discussed further below in conjunction with FIG. 3, of the event is recorded during step 250.

As shown in FIG. 2, during step 260, the connection broker 130 periodically handshakes with the mediator 400 and sends the usage records 300 to the mediator 150. If the connection broker 130 cannot connect to the mediator 400 after a maximum allowed time period or the user does not pay for the usage, execution of the application can be suspended.

It is noted that the usage records 300 sent during step 260 can optionally be accumulated over time and sent to the mediator 150 in a batch. Thus, even if the user device 110 is offline, the user can still be allowed to use the software application 120.

Once the user has reached a predefined limit, such as a maximum time period or a number of usage actions, the connection broker 130 will be required to contact the mediator 400 to ensure continued access to the software application 120.

FIG. 3 illustrates an exemplary usage record 300 incorporating features of the present invention. As previously indicated, a given usage record 300 is created by the client-side monitoring program 200 upon detection of a predefined usage event, such as the user accessing a save function of a given software application 120. As shown in FIG. 3, for each predefined usage event, the exemplary usage record 300 records an identifier of the software application 120, an identifier of the software vendor 180 associated with the software application 120, an identifier of the associated user device 110 and the associated operating system (OS), the function associated with the usage event, a time/date stamp, the file name and file size associated with the usage event, the action type and the financial charge for the usage event.

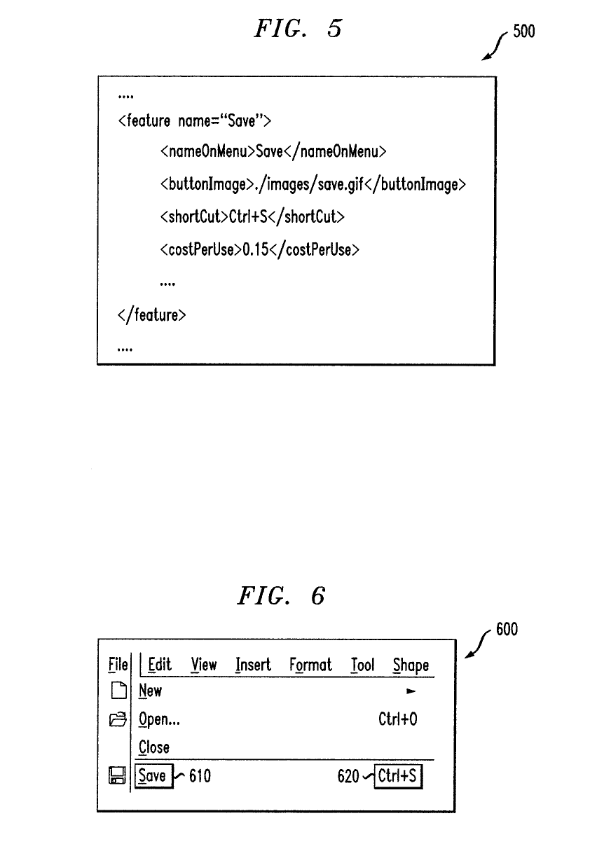

FIG. 4A is a flow chart describing an exemplary implementation of an exemplary software profile management routine 410 that may be implemented by the mediator 400 and incorporates features of the present invention. As shown in FIG. 4A, the software profile management routine 410 develops a software profile 170 during step 420 containing software usage agreements 500 for each monitored application 120 from the corresponding software vendors 180. As discussed further below in conjunction with FIG. 5, the exemplary software usage agreements 500 comprise, for example, the policies/rules indicating the names of the respective software functions, the (names of) image files to be matched for invocation of the functions, a shortcut, if any, for invoking the functions, and a detailed description of how the functions will be charged for, e.g. on a per-use basis in the client application.

As previously indicated, the connection broker 130 in the user device 110 sends usage records 300 to the centralized mediator 400 for further processing. FIG. 4B is a flow chart describing an exemplary implementation of an exemplary usage analysis routine 430 that may be implemented by the mediator 400 and incorporates features of the present invention. During step 440, the usage analysis function 150 of the mediator 400 compiles and provides usage analysis reports to the users and/or software vendors 180.

FIG. 4C is a flow chart describing an exemplary implementation of an exemplary billing management routine 450 that may be implemented by the mediator 400 and incorporates features of the present invention. During step 460, the billing management function 160 charges the user 110 for using the functions in the application based on the usage agreements 500 and the usage reports 300.

FIG. 5 is an exemplary representation of a software usage agreement 500 for a given monitored application 120, as provided by the software vendor 180. The software usage agreement 500 may be provided and stored, for example, in an XML format. As previously indicated, the exemplary software usage agreements 500 comprise, for example, the policies/rules indicating the names of the respective software functions, the (names of) image files to be matched for invocation of the functions, a shortcut, if any, for invoking the functions, and a detailed description of how the functions will be charged for, e.g. on a per-use basis in the client application 120.

It is noted that the software usage agreement 500 for a given monitored application 120 can optionally be stored at the user device 110, in addition to the mediator 400. The client-side software usage agreement 500 allows the usage capturer 140 of the user device 110 to filter the usage actions that are recorded in the usage records 300, for example, to only transmit to the mediator 400 those actions that correspond to functions that will trigger a charge.

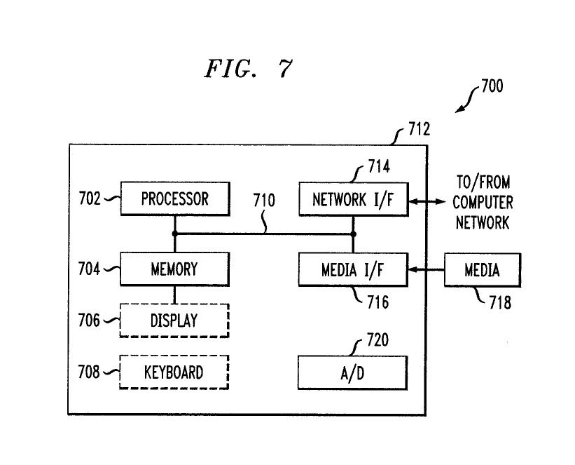

FIG. 6 illustrates an exemplary graphical user interface (GUI) that allows a user to implement, for example, a save operation in an application 120. As shown in FIG. 6, the exemplary GUI 600 allows a user to implement a save operation by selecting a menu option 610 or by a keystroke shortcut 620. When the user selects the “Save” operation 610 or 620, the action is captured, recorded and sent to mediator 400. An exemplary usage record 300 for an exemplary save operation is shown in FIG. 3. An exemplary software usage agreement 500 for an exemplary save operation is shown in FIG. 5. The mediator 400 charges the user based on the usage agreement 500 stored in the software profile 170.

Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. FIG. 7 depicts a computer system 700 that may be useful in implementing one or more aspects and/or elements of the present invention. With reference to FIG. 7, such an implementation might employ, for example, a processor 702, a memory 704, and an input/output interface formed, for example, by a display 706 and a keyboard 708. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 702, memory 704, and input/output interface such as display 706 and keyboard 708 can be interconnected, for example, via bus 710 as part of a data processing unit 712. Suitable interconnections, for example via bus 710, can also be provided to a network interface 714, such as a network card, which can be provided to interface with a computer network, and to a media interface 716, such as a diskette or CD-ROM drive, which can be provided to interface with media 718.

Analog-to-digital converter(s) 720 may be provided to receive analog input, such as analog video feed, and to digitize same. Such converter(s) may be interconnected with system bus 710.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 702 coupled directly or indirectly to memory elements 704 through a system bus 710. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 708, displays 706, pointing devices, and the like) can be coupled to the system either directly (such as via bus 710) or through intervening I/O controllers (omitted for clarity).

Network adapters such as network interface 714 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 712 as shown in FIG. 7) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 718 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Method steps described herein may be tied, for example, to a general purpose computer programmed to carry out such steps, or to hardware for carrying out such steps, as described herein. Further, method steps described herein, including, for example, obtaining data streams and encoding the streams, may also be tied to physical sensors, such as cameras or microphones, from whence the data streams are obtained.

It should be noted that any of the methods described herein can include an additional step of providing a system comprising distinct software modules embodied on a computer readable storage medium. The method steps can then be carried out using the distinct software modules and/or sub-modules of the system, as described above, executing on one or more hardware processors 702. In some cases, specialized hardware may be employed to implement one or more of the functions described here. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A client-side method for monitoring usage of a portion of a software application by a user, said method comprising:
monitoring actions of said user at an image level;
determining if one or more predefined user actions are detected, wherein said one or more predefined user actions comprise usage of a function of said software application; and
providing a notification of said one or more predefined user actions to a mediation server for payment processing.

2. The method of claim 1, further comprising the step of suspending execution of said software application if payment is not made for said usage.

3. The method of claim 1, further comprising the step of suspending execution of said software application if said notification is not received by said mediation server.

4. The method of claim 1, wherein said step of providing said notification is performed periodically for a plurality of said notifications.

5. The method of claim 4, wherein said user can use said software application in an offline mode for a period of time provided one or more predefined criteria are not violated.

6. The method of claim 1, wherein said mediation server for payment processing determines a license fee for said predefined user actions based on an amount of use.

7. The method of claim 1, wherein said mediation server for payment processing determines a license fee for said predefined user actions based on an identifier of said function associated with a given predefined user action.

8. The method of claim 1, wherein said monitoring step further comprises the step of sampling user interface interactions of said user with said software application.

9. The method of claim 8, wherein said sampling step further comprises the step of monitoring one or more of menu selections, mouse button selections, mouse button click operations, additional user interface widgets and short cut keystrokes.

10. The method of claim 8, wherein said sampling step further comprises the steps of sampling an image in a vicinity of said user action and matching said sampled image to determine a type of selection and instance of said selection.

11. The method of claim 10, wherein said sampling step is performed using a Screen Scraping tool.

12. The method of claim 8, wherein said sampling step is performed using a user interface widget.

13. The method of claim 1, wherein said mediation server determines said payment based on one or more of software usage agreements and usage reports.

14. The method of claim 1, wherein said mediation server determines said payment based on one or more software usage agreements for one or more monitored software applications.

15. The method of claim 14, wherein said software usage agreements comprise one or more of policies and rules for specifying a payment amount for one or more functions of a given software application.

16. The method of claim 1, further comprising the step of providing one or more usage analysis reports to one or more of said user and a software vendor.

17. A client-side system for monitoring usage of a portion of a software application by a user, said system comprising:
a memory; and
at least one processor, coupled to the memory, operative to:
monitor actions of said user at an image level;
determine if one or more predefined user actions are detected, wherein said one or more predefined user actions comprise usage of a function of said software application; and
provide a notification of said one or more predefined user actions to a mediation server for payment processing.

18. The system of claim 17, wherein said processor is further configured to suspend execution of said software application if payment is not made for said usage.

19. The system of claim 17, wherein said processor is further configured to suspend execution of said software application if said notification is not received by said mediation server.

20. The system of claim 17, said notification is provided periodically for a plurality of said notifications.

21. The system of claim 20, wherein said user can use said software application in an offline mode for a period of time provided one or more predefined criteria are not violated.

22. The system of claim 17, wherein said mediation server for payment processing determines a license fee for said predefined user actions based on an amount of use.

23. The system of claim 17, wherein said mediation server for payment processing determines a license fee for said predefined user actions based on an identifier of said function associated with a given predefined user action.

24. The system of claim 17, wherein said actions are monitored by sampling user interface interactions of said user with said software application.

25. An article of manufacture for client-side monitoring of usage of a portion of a software application by a user, said article of manufacture comprising a tangible machine readable recordable medium containing one or more programs which when executed implement the steps of:
monitoring actions of said user at an image level;
determining if one or more predefined user actions are detected, wherein said one or more predefined user actions comprise usage of a function of said software application; and
providing a notification of said one or more predefined user actions to a mediation server for payment processing.
